(19) United States
(12) Patent Application Publication
(10) Pub. No.: US 2026/0179416 A1
(43) Pub. Date: Jun. 25, 2026

(54) DETERMINATION OF A STATE OF A FLUID-OPERATED SYSTEM OF A VEHICLE

(71) Applicant: Zoox, Inc., Foster City, CA (US)

(72) Inventors: Soheil Mohagheghi FARD, Fremont, CA (US); Sunny MAKKAR, Newark, CA (US); Rahul Dhananjay SAWANT, Santa Clara, CA (US); Samay SHAH, Oakland, CA (US); Shen SHEN, Cupertino, CA (US); Zunya SHI, Sunnyvale, CA (US); Sharath Kumar THIRUPATHYSWAMY, Livermore, CA (US); Venkata Seetarama Hari Karthik VEDAM, Foster City, CA (US); Qinling ZHENG, Redwood City, CA (US)

(21) Appl. No.: 18/988,724

(22) Filed: Dec. 19, 2024

(51) Int. Cl. G07C 5/08; B60G 17/018; B60G 17/0185; B60G 17/019; B60H 1/00; G07C 5/00

(52) U.S. Cl. CPC G07C 5/0808; B60G 17/0182; B60G 17/0185; B60G 17/019; B60H 1/00878; G07C 5/006; B60G 2400/51

(57) ABSTRACT

Vehicles, methods, and non-transitory computer-readable media are disclosed, relating to receiving sensor data indicating a first characteristic of a fluid-operated system of a vehicle, estimating a second characteristic of the system, based at least in part on the sensor data and at least in part on a model representing a correlation between the first characteristic and the second characteristic, determining, based at least in part on the second characteristic, a state of the system; and controlling the vehicle based at least in part on the state of the system.

### BACKGROUND

A vehicle may include one or more systems that utilize a working fluid for their operation. Examples of such fluid-operated systems include suspension systems, which may improve passenger comfort and vehicle performance by absorbing shocks and vibrations as the vehicle travels across uneven surfaces. Further examples include refrigeration systems managing temperature control within the passenger cabin and cooling various components of the vehicle. The operational state and performance of these systems may be monitored to ensure reliable operation, plan maintenance, and prevent unexpected breakdowns that could impact vehicle functionality and efficiency.

### BRIEF DESCRIPTION OF DRAWINGS

The detailed description is described with reference to the accompanying figures. The use of the same reference numbers in different figures indicates similar or identical components or features.

FIGS. 1A and 1B schematically illustrate suspension systems of an example vehicle, comprising a spring and an accumulator.

FIG. 2A is a diagram illustrating pressure measurements of a hydraulic fluid in the suspension system and an estimated pressure of the gas in the suspension system's accumulator.

FIG. 2B is a diagram illustrating a predicted gas pressure based on a rolling forecast model.

FIG. 3 schematically illustrates a refrigeration system of an example vehicle.

FIG. 4A shows two diagrams, of which the first one illustrates a measured discharge pressure of a compressor of a refrigeration system that works as intended with adequate refrigerant levels, and wherein the second one illustrates a cumulative sum of the measured discharge pressure.

FIG. 4B shows the two diagrams for a refrigeration system that is leaking refrigerant.

FIG. 5 depicts a flow chart of a process of determining a state of a suspension system.

FIG. 6 depicts a flow chart of a process of determining a state of a refrigeration system.

FIG. 7 depicts a block diagram of an example vehicle system.

### DETAILED DESCRIPTION

This disclosure presents methods, systems, and computer-readable media for determining an operational state of a vehicle system and for controlling the vehicle based on that state. The system may be a fluid-operated subsystem, such as a suspension system or refrigeration system. The disclosed procedures involve measuring a first characteristic of the subsystem and using this measurement to infer a second characteristic, or a state, of the subsystem. For example, the first characteristic could be the pressure of the working fluid in a suspension system or the discharge pressure of a compressor in a refrigeration system. This information may be used to determine other parameters, such as the pressure of a gas pressurizing the working fluid of the suspension system, the refrigerant level in the refrigeration system, or the general operational state of the refrigeration system. The present disclosure allows for sensor data, obtained by monitoring one characteristic of the subsystem, to be leveraged to make determinations about other characteristics of the subsystem, without requiring direct measurement of those additional characteristics.

By analyzing patterns and correlations within the sensor data, it is possible to deduct information about various parameters of the subsystem, such as the precharge gas pressure in the suspension system or the operational state of the refrigeration system. For example, variations in working fluid pressure may indicate changes in the precharge gas pressure, while shifts in compressor discharge pressure may reflect an insufficient refrigerant level.

The present disclosure describes systems and processes that can receive and process data, including historical data, real-time sensor data, and system characteristics retrieved directly or indirectly from such sensor data, to be processed online by a computing component of the vehicle or offline or at the edge of a computing network, i.e., outside the computing component of the vehicle.

Offline or edge processing of the data may provide advantages compared to systems where diagnostics are typically performed online in real time and are therefore constrained by the available processing capacity of the vehicle's computing resources. By shifting at least some of the data processing offline, the system may analyze larger datasets and run more computationally intensive models or algorithms. Such offline processing could cause deeper and more accurate diagnostics, such as historical trends, correlations, and virtual sensor outputs, to be processed. For instance, patterns indicating gradual degradation, leaks, or performance anomalies of the fluid-operated subsystems that might be missed in lighter weight processing schemes may be identified more reliably when processing occurs offline or at the edge. Furthermore, offline or edge processing may allow for more advanced predictive diagnostics, such as forecasting system failures or performance issues using, for instance, machine learning models or other data-driven methods.

In the following description, a refrigeration system and a suspension system of a vehicle are presented as illustrative examples of how the general inventive concept can be implemented. These specific examples are provided solely for the purpose of explaining the inventive concept in a clear and accessible manner and should not necessarily be interpreted as limiting the scope of the present disclosure. It is understood that the technologies disclosed herein can be applied to other types of fluid-operated systems, including but not limited to various hydraulic, pneumatic, or thermodynamic systems, as well as other applications where monitoring and control of system states are desired.

In an example implementation of the present disclosure, sensor data indicating a pressure of working fluid of a suspension system is utilized to estimate a pressure of a gas in the suspension system. The gas is provided to precharge the working fluid in the suspension system and may therefore also be referred to as a precharge gas. As the gas might gradually leak over time, the performance of the suspension system may be degraded, and the vehicle be subject to a service procedure. The estimated pressure of the precharge gas may hance be utilized to determine a state of the system and allow the vehicle to be controlled based on the determined state.

The example suspension system generally comprises a spring and a damper assembly that couples a wheel to the chassis of the vehicle. The spring may be configured to absorb the impact from vibrations and road irregularities, while the damper may be configured to control the spring's oscillations to stabilize the vehicle. The spring may use a combination of a working fluid, such as a hydraulic fluid, and a pressurized gas to absorb the impacts. The precharge gas the and the hydraulic fluid may be separated by a movable separator that defines a gas chamber for the gas and a hydraulic fluid chamber for the hydraulic fluid. During compression of the spring, for example in response to the wheel encountering a bump or a pothole, the hydraulic fluid pushes against the separator to compress the gas in the gas chamber, thereby storing the impact energy as potential energy in the gas chamber. During rebound, the pressurized gas is allowed to expand and causes the spring to extend.

The suspension system may further comprise an accumulator, comprising a pressurized chamber which may be divided into a gas chamber configured to be filled with a pressurized gas and a hydraulic fluid chamber configured to accommodate hydraulic fluid. The gas may be separated from the hydraulic fluid in the pressurized chamber by a separator, such as a piston or a membrane. Beneficially, the accumulator may serve as a storage device assisting in regulating the hydraulic fluid pressure in the system. When the system pressure is higher than the precharge pressure in the accumulator (i.e., the pressure in the gas chamber), the hydraulic fluid may flow into the hydraulic chamber of the accumulator, compressing the gas and storing energy. When the system pressure drops, the compressed gas may expand and push the stored hydraulic fluid back into the system, maintaining the system pressure.

The behavior and performance of the suspension system may hence be determined at least in part based on the amount of the gas in the gas chambers of the springs and the accumulator. Insufficient precharge gas may reduce the suspension's travel range, making more likely to “bottom out” when encountering bumps or potholes. This means that the suspension may reach its limits during compression, resulting in a harsher ride as the chassis and wheels are more likely to come into direct contact. Furthermore, a lack of precharge gas may disrupt the balance between the hydraulic fluid and the gas, making the suspension less responsive and affecting vehicle handling. In the accumulator, precharge may stabilize hydraulic pressure by allowing fluid to flow in and out as the pressure fluctuates. Without enough gas, the accumulator may become less effective at buffering these changes, leading to erratic hydraulic pressure levels.

As the precharge gas in the springs and the accumulator has been observed to gradually leak, it is therefore of interest to monitor the pressure of the precharge gas in the gas chambers to ensure proper operation of the suspension system. According to the present disclosure, this may be achieved by monitoring the pressure of the working fluid, i.e., the hydraulic fluid, and employing a model to estimate the pressure of the gas based on the hydraulic fluid pressure.

As mentioned above, another example implementation of the present disclosure involves using sensor data indicating a discharge pressure of a compressor of a refrigeration system to determine a state of the refrigeration system. The refrigeration system may form part of a vehicle's thermal management system, which also may include a cooling system.

The refrigeration system may include one or more of a compressor, a condenser, an expansion valve, and an evaporator. During operation, the compressor circulates refrigerant through the system, compressing it into a high-pressure gas, which then flows through the condenser, where it cools and condenses into a liquid. This high-pressure liquid refrigerant may then pass through the expansion valve, where it may undergo rapid expansion and cool before entering the evaporator. In the evaporator, the refrigerant may absorb heat from the surrounding air, cooling the passenger cabin or the targeted components. The refrigerant may thereafter return to the compressor to repeat the cycle.

As mentioned above, the thermal management system may also comprise a cooling system, The cooling system, which may employ a water-based working fluid for its operation, may be utilized to manage the operating temperature of the powertrain, batteries, and computing components for controlling the vehicle. The cooling system typically comprises a radiator, a pump, and a thermostat. The pump circulates a liquid coolant, such as water, through the heat-generating components, absorbing excess heat. The heated coolant then flows into the radiator, where an air flow may cool it before recirculating.

The cooling system and the refrigeration systems may cooperate to achieve comprehensive thermal management. The cooling system may be employed to address bulk thermal loads from the powertrain and batteries, while the refrigeration system may enable finer control over temperatures in the passenger cabin and heat-sensitive electronic components. In some examples, the refrigeration system may be used to cool the coolant of the cooling system. The heat transfer between the two systems may, for example, take place in condenser or chiller devices.

The efficiency of the operation of the refrigeration system often relies on maintaining an adequate level of refrigerant, which serves as the working fluid responsible for absorbing and transferring heat. If the refrigerant level drops too low, several performance issues may arise. For example, insufficient refrigerant may reduce the system's capacity to absorb heat within the evaporator, resulting in inadequate cooling in the passenger cabin and potentially impacting the temperature control of components that rely on this system. Low refrigerant levels may also force the compressor to work harder to circulate the remaining refrigerant, leading to increased energy consumption and accelerated wear on the compressor.

In addition to reduced cooling efficiency, low refrigerant levels may lead to pressure imbalances within the refrigeration system. Under normal conditions, the pressure of the refrigerant may be regulated to enable smooth transitions between the phases (gas and liquid) as the refrigerant moves through the system. When refrigerant levels are too low, these pressure levels may fluctuate unpredictably, causing unstable performance.

Given that refrigerant can gradually leak from the system over time, it is of interest to monitor the performance of the refrigeration system to ensure it meets or exceeds a predetermined standard. According to the present disclosure, this may be achieved by monitoring the discharge pressure of the compressor and employing a model to determine a state of the refrigeration system, and/or a level of the refrigerant in the refrigeration system.

In some examples, a method is provided, comprising receiving sensor data indicating a first characteristic of a fluid-operated system of a vehicle. The method further comprises estimating a second characteristic of the system, based on the sensor data and at least in part on a model representing a correlation between the first characteristic and the second characteristic, and determining a state of the system based on the second characteristic. The state of the system may be used to control the vehicle.

In some examples, the system is a suspension subsystem, the first characteristic a pressure of a working fluid of the suspension subsystem, and the second characteristic a pressure of a gas arranged to pressurize the working fluid. The gas may be arranged in a gas chamber of a spring and/or accumulator of the suspension subsystem. The method may further comprise predicting, based on the model, a future pressure of the gas and determining whether the current or predicted pressure of the gas deviates from a target pressure, a target pressure range, or a pressure threshold. The target pressure or the pressure threshold may be dynamic targets that may vary, for instance, with the ambient temperature or other operational or environmental conditions.

In some examples, the system comprises a refrigeration subsystem and the first characteristic is a discharge pressure of a compressor of the refrigeration subsystem. The method may further comprise monitoring, based on the model, an average of the discharge pressure over a period of time, determining, based on the model, that the average is below a predetermined target pressure, and determining the state based on the average being below the predetermined target pressure.

The model may include a deviation detection model to identify anomalies, issues, or faults in the fluid-operated system by analyzing deviations in a monitored parameter, such as the first characteristic or the second characteristic, from an expected behavior. The model may involve the establishment of a baseline or reference range for the parameter under normal operating conditions and use this as a benchmark to detect deviations that could signal potential faults.

The fluid-operated system may be any system that relies on the use of a fluid—such as a liquid, gas, or a combination of both—as a working fluid to enable or enhance its operation. It is appreciated that this fluid can play various roles depending on the system's specific function. For example, in a suspension system, a fluid such as a hydraulic oil might be used to absorb and dissipate energy from road impacts, whereas in a refrigeration system, a refrigerant medium is circulated to manage temperature through heat absorption and release. In a fluid-operated system, the fluid typically undergoes pressure changes, flows through different components, or phase transitions to fulfill the system's function. These systems may include components like pumps, compressors, reservoirs, or accumulators to manage and control the fluid's behavior.

A characteristic, such as the first characteristic and the second characteristic of the fluid-operated system mentioned above, may include a measurable property or attribute of the working medium or the system itself, which may provide information about the condition or behavior of the working medium or system. Characteristics may include physical properties that can be quantified, such as pressure, temperature, flow rate, or volume.

The model may include a representation, often mathematical or computational, that describes the relationship between the first characteristic (e.g., working fluid pressure or compressor discharge pressure) and the second characteristic (e.g., pressure of the gas in the accumulator, or a state or refrigerant level of the refrigeration system). The model may provide a tool for predicting or estimating the second characteristic based on the first characteristic. The model may be constructed from theoretical principles, empirical data, or a combination of both. The model could involve equations, algorithms, or machine learning techniques to capture and represent the behavior of the system under various conditions.

The state of a system may describe the condition or performance level of the system. More specifically, the state may refer to the suspension system's capability to absorb kinetic energy from the wheel, which may be determined by the amount of gas in the springs or the accumulator. The state may also refer to the refrigeration system's capability of transferring heat, for example from heat-generating components of the vehicle. In an operational or normal state, the system may comprise enough working fluid to function as designed. This state may be determined by verifying that the first and/or second characteristic meets or exceeds a reference value. In a degraded or malfunction state, the performance of the system may have dropped from its normal level. The suspension or refrigeration system may still be functional, but its capacity to absorb energy from, e.g., road impacts or heat-generating components, may be compromised. Terms like “degraded”, “impaired, or “need for service” may be used to describe this state.

It will be appreciated that transitions between a normal state and a degraded state are often not abrupt but may occur gradually over time due to gradual leakage of working fluid from the system. Therefore, it is of interest to regularly monitor the first characteristic and use the model to determine the current state or predict a future point in time when the service or maintenance might be needed. Beneficially, this allows for service and maintenance to be planned and performed before the system enters a degraded state.

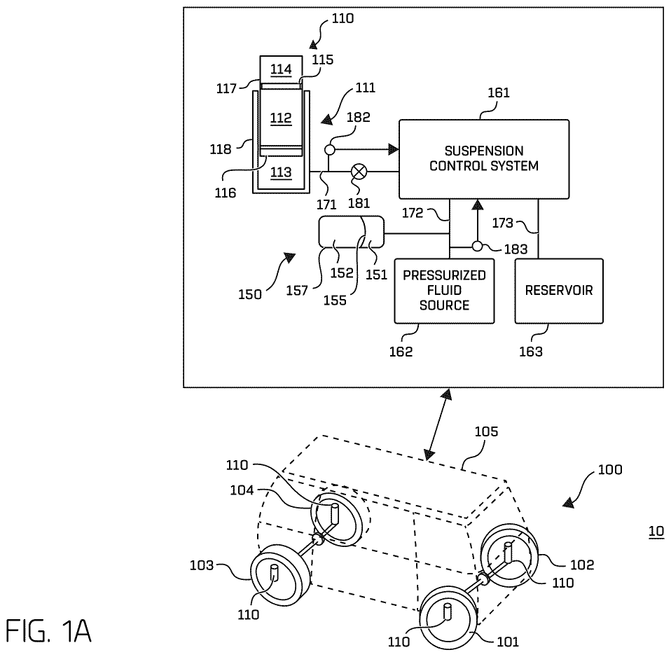

The techniques described herein can be implemented in a number of ways to determine a state of the system. Examples are provided below with reference to FIGS. 1-7. Examples are discussed in the context of autonomous vehicles; however, the methods, apparatuses, and components described herein can be applied to a variety of systems are not limited to autonomous vehicles. In one example, the techniques described herein may be utilized in driver-controlled vehicles.

FIG. 1A illustrates a view of an example vehicle 100, which is ghosted in broken lines to help illustrate internally positioned components. The vehicle 100 may be a driverless vehicle or a driver-controlled vehicle. The vehicle 100 may be any configuration of vehicle, such as, for example, a van, a sport utility vehicle, a cross-over vehicle, a truck, a bus, an agricultural vehicle, and a construction vehicle. The vehicle 100 may be powered by one or more internal combustion engines, one or more electric motors, hydrogen power, any combination thereof, and/or any other suitable power sources.

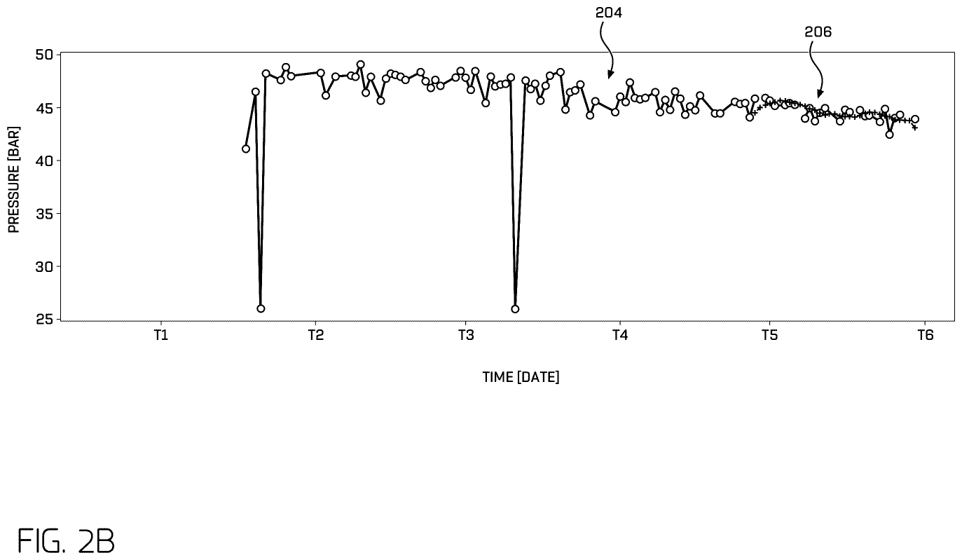

The vehicle 100 may comprise one or more fluid-operated system, such as one or more suspension systems 10 and/or one or more refrigeration systems 20. In the present example, a suspension system 10 is disclosed. A refrigeration system 30 will be discussed later, with reference to FIG. 3. Although these systems are described separately in FIGS. 1A, 1B, and 3, it will be appreciated that the vehicle 100 may comprise both a suspension system 10 as shown in FIGS. 1A and 1B, and a refrigeration system 30 as shown in FIG. 3.

The vehicle 100 may travel on a surface, such as, for example, any road surface (e.g., tarmac, asphalt, gravel, etc.). The surface may include areas of unevenness, such as, for example, a depression (e.g., a pothole or a dip in the surface) or a bump or protrusions (e.g., a speed bump or heave in the surface). As the vehicle 100 travels across such uneven regions, the surface exerts a force on the wheel or wheels 101-104 that may be transmitted through the wheel(s) 101-104 to a chassis 105 of the vehicle via a suspension system 10 coupling the wheels 101-104 to the vehicle chassis 105. An example of such a suspension system 10 will now be described with reference to FIG. 1A.

The suspension system 10 comprises a plurality of springs (schematically represented by spring 110 in FIG. 1A), each coupling the chassis 105 of the vehicle 100 to a respective wheel of the vehicle 100. Thus, each of the four wheels 101-104 of the vehicle 100 may be coupled to the chassis 105 by a respective spring 110. The springs 110 may be arranged to allow the wheels 101-104 to move relative to the chassis 105, for example in response to the wheels encountering road irregularities and areas of unevenness. However, it is to be noted that other configurations are also possible. The vehicle 100 may, for example, comprise less than four wheels or more than four wheels. Further, a wheel may be coupled to the chassis by two or more springs.

The spring 110 may comprise a hydraulic fluid chamber 111 that may be divided by a damper piston 116 into a damper retraction chamber 112 and a damper extension chamber 113. Further, the spring 110 may comprise a gas chamber 114 which may be separated from the hydraulic fluid chamber 111 by a separator 115. Other configurations are however possible, such as the spring 110 comprising two or more hydraulic fluid chambers or two or more gas chambers.

The operation of the spring 110 may be controlled by a suspension control system 161, which may be configured to supply a working fluid, such as a hydraulic fluid, from a pressurized fluid source 162 (e.g., a hydraulic pump) to the spring 110 and discharge hydraulic fluid to a hydraulic fluid reservoir 163.

Although a single suspension control system is depicted in FIG. 1A, there may be provided a suspension control system 161 for each axle of vehicle 100, such that a first suspension control system 161 is arranged to control the operation of the springs at the front axle of the vehicle 100 and a second suspension control system 161 is arranged to control the operation of the springs at the rear axle of the vehicle 100. There may be provided a separate pressurized fluid source 162 for each of the suspension control systems 161 or a pressurized fluid source 161 that is common to both suspension control systems 161. Similarly, there may be provided a separate reservoir 163 of each of the suspension control systems 161, or one that is common to both. In further examples, there may be provided a single suspension control system 161 that is common to all springs of the exemplary vehicle 100 illustrated in FIG. 1A.

The spring 110 may be a hydropneumatic spring 110 comprising a spring cylinder 117 and a damper cylinder 118, wherein the spring cylinder 117 may be telescopically arranged within the damper cylinder 118 to allow the spring 110 to extend and retract. Thus, the damper cylinder 117 may be mechanically coupled to the wheel 101 and the spring cylinder 118 may be mechanically coupled to the chassis 105, or vice versa. The damper cylinder 118 and the spring cylinder 117 may form a spring 110 with a combined spring and damper functionality, as will be described in the following with reference to FIG. 1A. The spring 110 depicted in FIG. 1A may also be referred to as a strut.

The damper cylinder 118 and the spring cylinder 117 may together define the hydraulic fluid chamber 111, which may have a volume that varies as the spring 110 extends and retracts. In the present example, the hydraulic fluid chamber 111 defines the damper extension chamber 113 and the damper retraction chamber 112, which comprise hydraulic fluid. The extension chamber 113 and the retraction chamber 112 are separated from each other by the damper piston 116, which may be coupled to the spring cylinder 117 such that the spring cylinder 117 and the damper piston 116 move relative to the damper cylinder 118 as the spring extends and retracts.

The spring cylinder 117 may further comprise the gas chamber 114, which may be separated from the retraction chamber 112 by the movable separator 115. In the present example, an end of the spring cylinder 117 facing away from the damper cylinder 118 may be closed such that the gas chamber 114 is defined between the closed end of the spring cylinder 117 and the separator 115. The separator 115 may be understood as a piston or membrane that can move relative to the spring cylinder 117 and the damper cylinder 118, and whose position may be determined at least in part by the interaction of forces from the gas in the gas chamber and the hydraulic fluid in the retraction chamber 112. In some examples, the separator 115 may be referred to as a floating piston 115.

In the example of FIG. 1A, an increased pressure in the hydraulic fluid chamber 111 (and hence in the retraction chamber 112) of the spring 110 may cause the separator 115 to move to compress the gas in the gas chamber 114. Accordingly, a decreased pressure in the hydraulic fluid chamber 111 may cause the separator 115 to move to reduce the pressure in the gas chamber 114. Beneficially, this arrangement allows the gas chamber 114 to absorb and release energy from relative movements between the wheel 101 and the chassis 105.

The separator 115 in the spring 110 may be formed as a piston that is sealed against the interior wall of the spring cylinder 117. The sealing may be provided to hinder hydraulic fluid from entering the gas chamber 114 and gas from escaping the gas chamber 114 and leaking into the hydraulic fluid chamber 111.

In examples wherein the damper functionality is provided by a component that is separate from the spring 110, the damper piston 116 may be omitted and the hydraulic fluid allowed to flow between the retraction chamber 112 and the extension chamber 113 without a damping flow resistance. Put differently, the retraction chamber 112 and the extension chamber 113 may be joined to form a common fluid chamber 111, and the damping provided by a structurally separate damper component that is coupled between the wheel 101 and the chassis 105 (not shown in FIG. 1A).

The hydraulic fluid may be conveyed in one or more first fluid lines 171 extending between the spring 110 and the suspension control system 161. A second fluid line 172 may be arranged to supply the suspension control system 161 with pressurized hydraulic fluid from the pressurized fluid source 162 and a third fluid line 173 may be arranged to allow hydraulic fluid to return to the reservoir 163. In some examples, the hydraulic fluid in the reservoir may be returned to the pressurized fluid source for recirculation to the suspension control system 161.

The addition or removal of hydraulic fluid from the hydraulic fluid chamber 111 may be controlled by an actuator controller (not shown) and one or more hydraulic control valves 181, which may be operated to regulate the amount of the hydraulic fluid in the hydraulic fluid chamber 111.

The pressure in the hydraulic fluid of the suspension system 10 may be indicated by sensor data received from one or more pressure sensors, such as first pressure sensor 182 in the first fluid line 171 or a second pressure sensor 183 in the second fluid line 172. The sensor data may be acquired continuously or periodically and utilized to monitor variations in the hydraulic pressure over time.

The hydraulic fluid may be an example of a working fluid, through which power can be transmitted in the vehicle suspension system. Typically, the hydraulic fluid is a substantially non-compressible liquid allowing efficient transmission of power at relatively high pressures. Examples of hydraulic fluids include mineral oil-based fluids and synthetic fluids.

The suspension system 10 may further comprise an accumulator 150, comprising a housing 157 accommodating a pressurized chamber which may be divided into a gas chamber 152 configured to be filled with a pressurized gas and a hydraulic fluid chamber 151 configured to accommodate hydraulic fluid. The hydraulic fluid chamber 151 may be fluidically connected to the pressurized fluid source 162 and the suspension control system 161 via a second fluid line 172.

The gas may be pressurized so as to precharge the hydraulic fluid in the pressurized chamber, from which the precharge gas may be separated by a separator 155, such as a piston or a membrane. Beneficially, the accumulator 150 may serve as a storage device assisting in regulating hydraulic fluid pressure in the system 10. When the system pressure is higher than the charge pressure in the accumulator 150, the hydraulic fluid may flow into the hydraulic fluid chamber 151 of the accumulator 150, compressing the gas and storing energy. When the system pressure drops, the compressed gas may expand and push the stored hydraulic fluid back into the system, maintaining the system pressure.

The gas chamber(s) 114, 152 may be filled with a gas that is relatively inert, thermally stable, and has a relatively low moisture content to help reducing corrosion inside the spring 100 and/or accumulator 150. Nitrogen is an example of such gas, with which the gas chamber(s) 114, 152 may be pre-pressurized to provide the desired behavior of the suspension system 10. The gas chamber(s) 114, 152 may comprise a refill valve for supply of additional gas in case the amount of gas present in the chamber(s) 114, 152 is determined to be below the threshold amount. The gas chamber(s) 114, 152 may be refilled by a service technician at a service station, or by gas stored in a gas reservoir of the vehicle.

The amount of gas in the spring 110 and the accumulator 150, and more specifically in the respective gas chambers 114, 152 of the spring 110 and the accumulator 150, may affect the performance, or operational state, of the suspension system 10. Insufficient precharge gas in the spring 110 may reduce the spring's 110 travel range, making it more likely to “bottom out” when encountering bumps or potholes. Furthermore, a lack of precharge may disrupt the balance between the hydraulic fluid and the gas, making the spring 110 less responsive and affecting vehicle handling. In the accumulator 150, the precharge may stabilize hydraulic pressure by allowing fluid to flow in and out as the pressure fluctuates. Without enough gas, the accumulator 150 may become less effective at buffering these changes, leading to erratic hydraulic pressure levels.

The pressure of the precharge gas in the suspension system 10, i.e., in the spring 110 and/or in the accumulator 150, may be determined based on the pressure of the hydraulic fluid. The pressure of the precharge gas may then be used to determine a state of the suspension system 10 and to control the vehicle 100 based on that.

FIG. 1B is a schematic illustration of an example vehicle 100, which may be configured similarly to the vehicle 100 shown in FIG. 1A. Hence, the vehicle 100 comprises a suspension system 10, comprising a plurality of springs (schematically represented by spring 110 in FIG. 1B). The spring 110 comprises a hydraulic fluid chamber 111 divided by a damper piston 116 into a damper retraction chamber 112 and a damper extension chamber 114. Further, the spring 110 comprises a gas chamber 114 which is separated from the hydraulic fluid chamber 111 by a separator 115. Similar to the suspension system 10 in FIG. 1A, the operation of the spring 110 may be controlled by a suspension control system 161, which is configured to supply the spring 110 with working fluid. The working fluid may be supplied to the spring 110 by means of a pump 165 drawing working fluid from a reservoir 163.

An actuator assembly 190 and one or more valve arrangements (not shown) may be provided to regulate the amount of working fluid in the hydraulic chamber 111. The actuator assembly 190 may comprise a cylinder 192 and an adjustable piston 193, which can be moved along the interior of the cylinder 192 to adjust the volume of working fluid in the hydraulic chamber 111. In the example shown in FIG. 1B, working fluid may be pushed into the hydraulic chamber 111 by moving the piston 193 downward, and be removed from the hydraulic chamber 111 by moving the piston 193 upward.

The actuator assembly 190 can be utilized to adjust the extension of the spring 110 and thus the chassis height of the vehicle 100 in relation to the ground surface. For a given precharge pressure (i.e., amount of gas in the gas chamber 114), increasing the amount of working fluid in the hydraulic chamber 111 may result in a certain extension of the spring 110, whereas decreasing the amount of working fluid in the hydraulic chamber 111 may result in a certain retraction of the spring 110. As the extension and compression characteristics of the spring 110 depend, inter alia, on the precharge gas pressure in the spring 110, the precharge gas pressure may be measured indirectly by varying the pressure of the working fluid (i.e., the suspension fluid) and observing the resulting extension/retraction of the spring 110.

The pressure of the working fluid may be measured by means of a pressure sensor 182 arranged in a first fluid line 171 connecting the spring 110 to the suspension control system 161. The extension or retraction of the spring 110 may be measured by means of an axial position sensor or a chassis position sensor arranged to measure a position of the chassis in relation to the surface on which the vehicle 100 is arranged. The amount of working fluid supplied to the hydraulic chamber 111 may be determined based on an actuator position sensor 191, which may be arranged to measure a position of the piston 193 regulating the amount of working fluid supplied to, or removed from, the hydraulic chamber 111. By monitoring the displacement of the piston 193, the corresponding fluid displacement may be determined.

One or more of these parameters, i.e., the extension/retraction of the spring 110, the amount of working fluid supplied to the spring 110, and the pressure of the working fluid in the hydraulic chamber 111, may form a first characteristic of the suspension system. This first characteristic may be used as input when determining or estimating the pressure of the gas in the spring 110, i.e., the precharge gas provided in the gas chamber 114. The determining of the gas pressure may be based on a model describing a correlation between the first characteristic and the gas pressure.

In an example, the actuator may be operated to increase or reduce the pressure of the working fluid, for instance, by supplying or removing working fluid from the hydraulic chamber 111. When the pressure of the working fluid increases, the working fluid pushes against the separator 115, compressing the gas in the gas chamber 114. This compression results in a displacement or extension of the spring 110. Conversely, when the pressure of the working fluid decreases, the pressure in the gas chamber 114 is reduced, causing the spring 110 to retract. The extension or retraction of the spring 110 in response to changes in working fluid pressure/volume is influenced, among other factors, by the precharge pressure of the gas in the gas chamber 114. Specifically, if the precharge pressure is low, the gas offers less resistance to compression, and the spring 110 may extend more for a given increase in working fluid pressure. If the precharge pressure is high, the gas offers greater resistance to compression, and the spring 110 may extend less for the same increase in working fluid pressure.

By measuring both the pressure increase and/or volume change of the working fluid—such as through the actuator position sensor 191 and/or the working fluid pressure sensor 182—and correlating this data with the resulting movement of the spring 110, the precharge gas pressure can be inferred. This relationship may be determined using a model, such as a mathematical model based on theoretical calculations (e.g., using the ideal gas law), a calibration curve, or a lookup table generated from empirical data or simulations.

The model may further account for factors such as stiction and friction of the separator 115 and damper piston 116, as well as the temperature of the working fluid, which can influence system behavior.

In an example, the pressure of the gas in the spring 110 may be determined by moving the actuator piston 193 a defined distance to vary the volume of the working fluid in the spring 110 and measuring the corresponding change in the length of the spring 110. The difference between the displacement of the spring 110 and the displacement of the actuator piston 193 may be calculated as a stroke parameter. This stroke parameter, along with the initial working fluid pressure (i.e., the pressure prior to the actuator piston's 193 movement), can be used as input to a lookup table. The lookup table may correlate the initial working fluid pressure and stroke parameter to the precharge gas pressure.

The above measurements may be performed when the vehicle 100 is stationary to ensure that only the chassis height changes are included in the determination of the precharge gas pressure, and no other changes due to, e.g., road loads and other types of noise. The stationary position of the vehicle 100 may be determined based on, for example, a control state of the suspension control system 161, acceleration signals, and vehicle velocity.

The precharge gas pressure may be monitored over time and compared with a predetermined value, or threshold. The pressure dropping below this threshold may indicate a potential issue within the system, prompting a determination that the system 10 is in a “degraded” state. The degraded state may, for example, indicate that there is a need for service, such as a refill of the precharge gas. The degraded state may be determined, for instance, if any single pressure data point falls below the threshold. In other examples, a more conservative approach may be used, whereby the degraded state is only determined if the precharge pressure remains consistently below the threshold for a specified period.

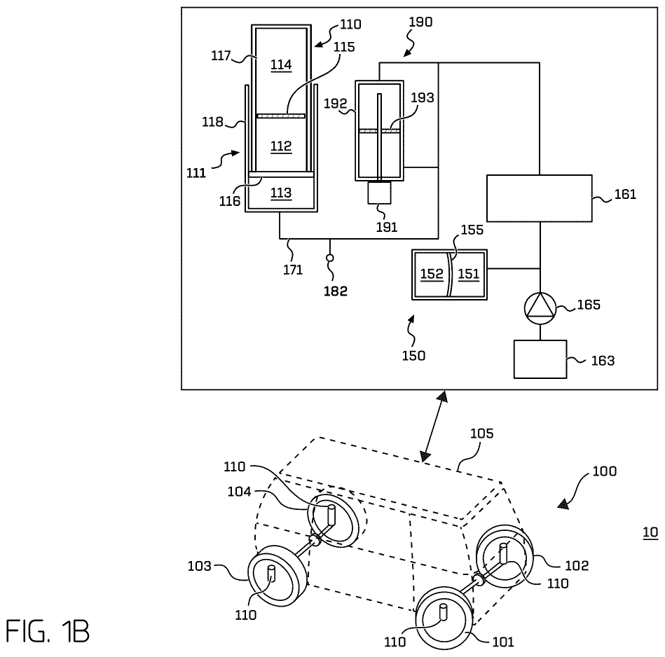

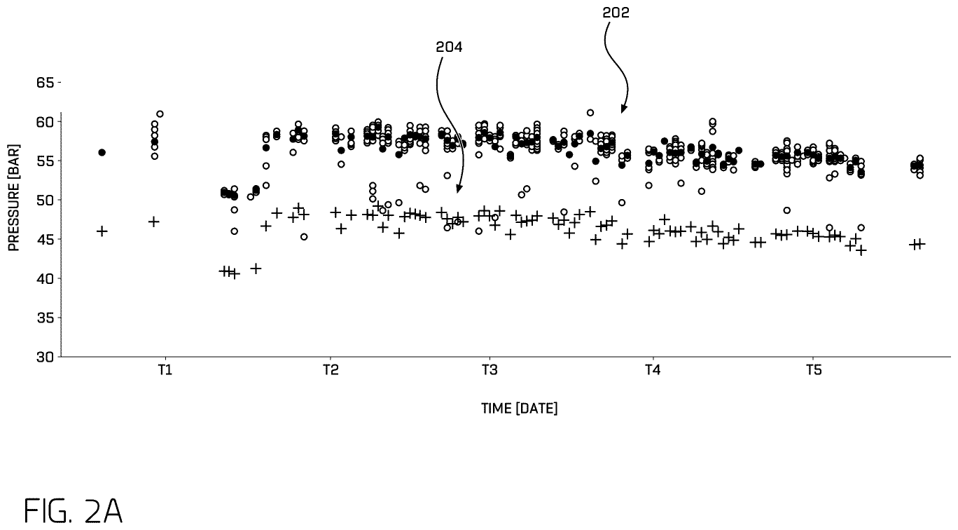

An example methodology for determining the pressure of the gas in the accumulator 150, as shown in FIGS. 1A and B, will now be described with reference to FIGS. 2A and 2B.

As mentioned above, the pressure of the hydraulic fluid may be indicated by sensor data received from, for example, the first pressure sensor 182 in the first fluid line 171 or the second pressure sensor 183 in the second fluid line 172. The sensor data may be acquired over a period of time and used as input in a model representing a correlation between the pressure of the fluid and the pressure of the gas in the accumulator 150.

FIG. 2A is a diagram illustrating pressure measurements of the hydraulic fluid in a suspension system 10, such as the one of FIG. 1A or 1B, over time. The vertical axis represents measured pressure (in bar) and the horizontal axis denotes time (date). Two sequences of data, indicating the first characteristic of the suspension system, are represented in the diagram. The first sequence 202 represents individual measurements of the pressure in the hydraulic fluid as well as a daily mean of those values. The individual measurements are indicated by hollow circles whereas the mean value is indicated by filled circles.

The diagram further comprises a second sequence 204, representing the second characteristic of the system. The second characteristic has been estimated based on a model describing a correlation between the first characteristic and the second characteristic. In the present example, the second sequence of data 204 represents an estimated pressure of the gas in the accumulator 150. The estimated pressure, indicated by crosses, is based on the daily mean value of the measured hydraulic fluid pressure and on an example model. The example model may be constructed from theoretical principles, empirical data, or a combination of both. In the present example, the model includes a subtracting a constant, such as 10 bars, from the daily mean value. It should be noted that this is merely an example, and that other models and correlations may be used, depending on the type and configuration of fluid-operated system and the characteristic measured.

The estimated pressure may be monitored over time and compared with a predetermined value, or threshold. When the pressure drops below this threshold, it may indicate a potential issue within the system, prompting a determination that the system 10 is in a “degraded” state.

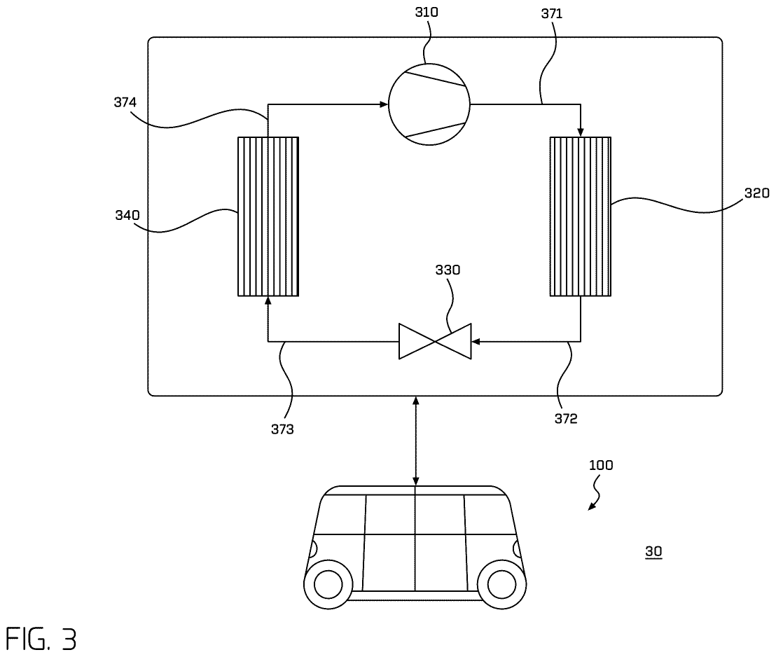

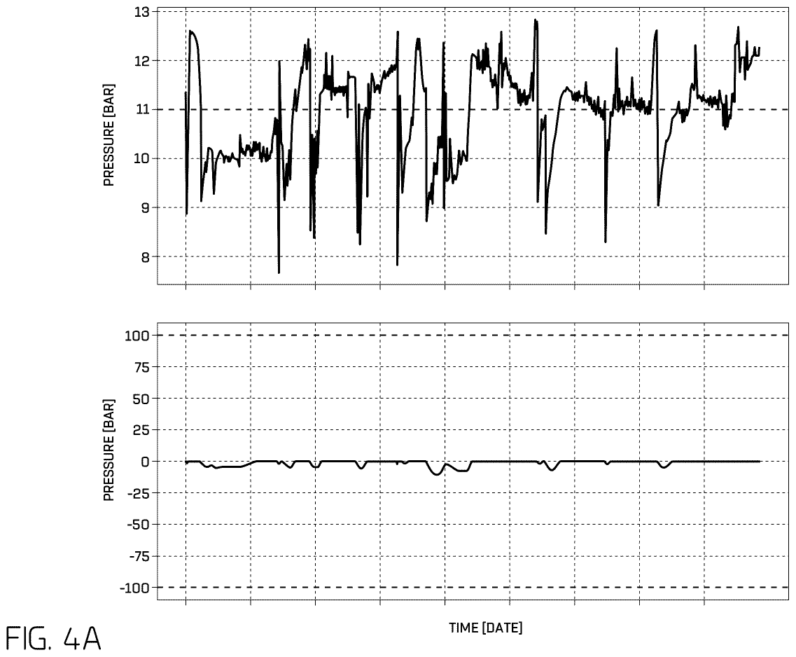

The determination of this degraded state may occur under different conditions. In an example, the system 10 may be determined as degraded if any single estimated pressure data point falls below the threshold, signaling an immediate alert. Alternatively, a more conservative approach may be used, whereby the degraded state is only determined if the determined pressure remains consistently below the threshold for a specified period. This approach helps avoid triggering an alert due to temporary or minor fluctuations, ensuring that the alert corresponds to sustained low-pressure conditions that are more indicative of an underlying problem. In an example, the model may comprise a cumulative sum equation accumulating differences in hydraulic fluid pressure over time to allow sustained low-pressure conditions to be determined. Sustained low-pressure conditions may be utilized to determine an insufficient precharge pressure and a need for refill. An example of such a cumulative sum model is described in further detail in connection with FIG. 4.

The estimated gas pressure may be employed to detect an event, such as a fault or malfunction of the suspension system, or a need for service. In case the monitored estimated gas pressure indicates an underlying problem, this may trigger the generation of an alert, allowing for the vehicle to be subject to maintenance, such as a refill of the gas, or requesting an intervention to restore normal operation of the system.

The estimated gas pressure values can also serve to forecast or predict a future pressure of the gas or point in time when there may be an issue with the system, such as the system being in a degraded or fault state or requiring service. By analyzing the trend of estimated gas pressure values, it is possible to identify patterns that indicate a gradual decline in pressure over time and, in some examples, estimate a time until the suspension system reaches a fault state.

FIG. 2B is a diagram showing an example, in which a rolling forecast model is used to project gas pressure values 5 days into the future, providing an advance indication of when pressures may approach or fall below the predefined threshold. FIG. 2B shows the sequence of data 204 representing the estimated pressure of the gas in the accumulator 150 (indicated by circles), as well as the rolling 5 days forecast 206 (indicated by crosses). In this example, the rolling 5 days forecast is based on an ARIMA (AutoRegressive Integrated Moving Average) model. The ARIMA model may leverage historical patterns within the pressure data to generate predictions. The ARIMA model may be continuously updated with new data to provide adaptive forecasts that can highlight impending pressure drops before they reach critical levels. With such a predictive capability, the system 10 may provide proactive alerts, allowing for scheduled maintenance or intervention to restore operation before a significant degradation occurs.

Several other types of models can be employed to generated predictions based on historical data. One alternative is exponential smoothing models, such as the Holt-Winters method, which may be effective for data with seasonality or trend components. These models may apply varying weights to recent and older data points, emphasizing more recent observations to generate accurate forecasts. Another approach would be to use machine learning regression models, such as linear regression, decision trees, or random forests, which can capture complex relationships in the data by learning patterns from historical values and other influencing factors. Neural networks, including recurrent neural networks (RNNs) and long short-term memory (LSTM) networks, may also be employed for this type of time series forecasting. Furthermore, Bayesian models may provide a probabilistic approach to forecasting by generating a distribution of possible future values rather than a single prediction. This can be advantageous when predicting under uncertainty, as Bayesian models allow for quantification of confidence intervals in the forecasted values.

As mentioned above, the techniques described herein may be utilized in various fluid-operated systems of a vehicle, such as the suspension system depicted in FIGS. 1 and 2A-B, or in a refrigeration system. An example of such a refrigeration system 30 is schematically outlined in FIG. 3.

FIG. 3 shows a vehicle 100, which may be configured similarly to the vehicle 100 shown in FIGS. 1A and 1B. The refrigeration system 30 may form part of the vehicle's 100 thermal management system and may be employed to manage the temperature within the passenger cabin and cooling high-demand electronic components, such as a vision system, a main AI of an autonomous vehicle 100, batteries, and compute modules. It will be appreciated that other thermal management systems may be used in parallel to, to in conjunction with, the refrigeration system 30, as will be discussed in connection with FIG. 4.

The refrigeration system 30 comprises a refrigeration circuit, formed by one or more fluid lines 371, 372, 373, 374 through which the working medium, in this case a refrigerant, may be circulated. The example system 30 comprises one or more compressors 310, condensers 320, expansion valves 330, and evaporators 340. The compressor 310 may be configured to circulate the refrigerant through the circuit, compressing it into a high-pressure gas flowing through a first fluid line 371. The first fluid line 371 conveys the high-pressure gas to the condenser 320, where the gaseous working fluid may cool and condense into a liquid. This liquid refrigerant may then pass through the expansion valve 330, which may be fluidically coupled to the condenser 320 through a second fluid line 372. When passing through the expansion valve 330, the refrigerant may undergo a rapid expansion and cool before entering the evaporator 340. The evaporator 340 may be coupled to the expansion valve 330 via a third fluid line 373, conveying the refrigerant to the evaporator 340. In the evaporator 340, the refrigerant may absorb heat from the surrounding air or another working fluid, such as water in a cooling system. The refrigerant may thereafter return to the compressor 310 via a fourth fluid line 374 to repeat the cycle.

The efficiency of the refrigeration system 30 may rely on maintaining an adequate level of the refrigerant in the circuit. Too low levels of refrigerant may reduce the system's capability to absorb heat within the evaporator 330 and may cause the compressor 310 to work harder than usual to circulate the refrigerant through the refrigeration system 30. In a well-functioning refrigeration system with adequate refrigerant, the compressor 310 discharge pressure typically remains within a specific range, depending on the system's design, the ambient temperature, etc. This pressure may reflect the normal load on the compressor as it compresses a sufficient volume of refrigerant. When there is too little refrigerant in the system, the compressor has less refrigerant to compress. This reduced load typically causes a decrease in the discharge pressure because the compressor 310 cycles through a smaller volume of refrigerant.

The discharge pressure of the compressor 310 may therefore, in some examples, form a first characteristic of the system 30, which may serve as input to a model used to estimate a second characteristic of the system 30. The second characteristic may be an operational status of the refrigerant system 30, or an indication whether the refrigerant level is adequate or too low. This information may, in turn, be used to determine a state of the refrigeration system and to control the vehicle 100, similar to what has been described above with reference to the suspension system 10 of FIGS. 1, 2A, and 2B.

Hence, by monitoring the discharge pressure of the compressor 310, it may be possible to detect when the discharge pressure consistently falls below the expected pressure range. This sustained low pressure may indicate that there is an issue with the operation of the refrigerant system, possibly caused by an insufficient amount of refrigerant. This may trigger an alert or the determination of the system as potentially degraded and in need of maintenance.

The discharge pressure of the compressor 310 may be measured by one or more pressure sensors, which may be integrated into the compressor 310 or provided as a separate component, for example measuring the pressure in the fluid line 371.

In some examples, a deviation model may be employed to determine the state of the system 30. This approach may be utilized for various types of systems, including the suspension system 10 and the refrigeration system 30. In the following, the refrigeration system 30 will be used as an example illustrating the deviation model approach.

The deviation model approach may involve monitoring the discharge pressure and comparing the sensor data to a baseline, or target pressure. If a deviation is detected, the model may trigger an alert or recommendation for corrective action, such as requesting a service or maintenance of the suspension system. Similarly, in a suspension system 10, sustained low-pressure deviations could indicate an insufficient amount of precharge gas requiring correction.

The deviation model may include the establishment of a baseline, or target pressure. This may be the expected range or target value for the monitored discharge pressure during normal operation. This baseline can be determined using historical data, system specifications, or statistical analysis. For instance, the mean and standard deviation of pressure values over a stable period can be used to create a reference range. It will be appreciated that the target value may be a dynamic target that varies with, for example, environmental parameters such as ambient temperature. The model may further comprise to incorporate metrics to quantify how much the monitored characteristic deviates from the baseline. This may include to calculate the difference between the measured discharge pressure and the target pressure, comparing measurements against predetermined thresholds to identify when they fall outside acceptable limits, and accumulating deviations over time to detect gradual shifts that may not be immediately apparent in individual measurements (also referred to as cumulative sum).

The model may apply rules or algorithms to classify deviations as normal variations or anomalies. A single measurement significantly outside the expected range may trigger an alert. A series of smaller deviations, sustained over a specified portions could also indicate an issue, such as a gradual leak or system degradation.

The following equation is an example of a deviation detection model applying a cumulative sum approach to detect potential fault states in a fluid-operated systems such as a suspension system 10 or a refrigeration system 30:

$$S = max ( 0 , S + ( {P}_{target} - {P}_{c urrent} - k ) \qquad ( Eq . 1 )$$

where S is the cumulative sum, P_{target} is the target average pressure, P_{current} is the current pressure, and k is a constant acting as a threshold, accounting for minor fluctuations that don't indicate a genuine low-pressure condition. By subtracting k from the difference, the equation may filter out minor dips below the target average pressure P_{target}, so that only more significant deviations may contribute to the cumulative sum S. Each time a new pressure measurement is taken, the equation calculates the difference between the target average pressure P_{target} (i.e., the ideal or expected pressure level) and the current pressure P_{current} measurement. This difference represents how much the current pressure P_{current} falls below the target P_{target}.

According to this example model, positive pressure differences (after adjusting for k) are added to the cumulative sum, gradually accumulating each time the pressure measurement Pₑᵤᵣᵣₑₙₜ falls below the target average pressure P_{target}. This accumulation allows the system to recognize sustained or repeated low-pressure conditions rather than reacting to single, isolated measurement. If the cumulative sum S drops below a predetermined target, or control limit, an alert may be triggered.

If the calculated difference is zero or negative, the equation uses the max function to reset the cumulative sum to zero. This helps ensuring that the sum only accumulates during periods of actual low-pressure conditions and clears whenever the pressure returns to normal or above the threshold, preventing false alarms. It should be noted that this is merely an example, and that other models and correlations may be used, depending on the type and configuration of fluid-operated system and the characteristic measured. The above model may be utilized both in a suspension system 10 (in which the hydraulic fluid pressure or the estimated gas pressure is the monitored parameter) as well as in a refrigeration system 30 (in which the discharge pressure of the compressor 310 may be the monitored parameter).

It will also be appreciated that sensor data indicating the discharge pressure of the compressor 310, the hydraulic pressure of a suspension system, or a precharge gas pressure of the same, may also be utilized to forecast or predict a future state of the system or a point in time when there may be an issue with the system. By analyzing trends in the monitored pressure, it is possible to identify patterns that indicate a gradual decline in pressure over time and, in some examples, estimate a time until the system reaches a fault state. This may, for example, be achieved using a forecast model similar to the ones discussed above in connection with FIG. 2B, including rolling forecast models and comparing the measured average discharge pressures with predetermined thresholds.

An example of a model employing a cumulative sum approach according to equation 1 to determine a state of an example refrigeration system 30 is illustrated in FIGS. 4A and B. FIG. 4A shows a normal scenario, where the refrigeration system works as intended with adequate refrigerant levels, whereas FIG. 4B shows a scenario where a refrigerant leak is detected. For each of the figures, the upper diagram displays the discharge pressure P_{current} (in bar) of the refrigeration compressor 310 over time, while the lower diagram displays the cumulative sum S according to equation 1. The horizontal axis is a time axis labeled with specific dates, representing the progression of pressure readings over time.

The discharge pressure P_{current} was measured at a minimum compressor speed and averaged over a 5-minute window. As shown in FIG. 4A, the discharge pressure P_{current} fluctuated around 11 bars, depending on the cooling demand. This pressure was therefore set to represent the target average pressure P_{target}, which is indicated in the upper diagrams as a dashed line at 11 bar. The target pressure P_{target} may, for example, be a function of ambient temperature.

The constant k was set to 1 bar to allow a 1 bar oscillation around the target average pressure P_{target} before it is summed with the error. The line representing the cumulative sum S values indicated in the lower diagram in FIG. 4A remains relatively flat and close to zero, with minor fluctuations. No meaningful accumulation of deviations can be determined, and the discharge pressure rarely stays below the target average pressure P_{target} for extended periods. The cumulative sum S values remain well within the control limit (dashed line at −100 in the lower diagram), confirming that the system is operating within expected parameters without any signs of degradation or refrigerant leakage.

FIG. 4B shows the discharge pressure P_{current} (upper diagram) and the cumulative sum S (lower diagram) for a system that is leaking refrigerant. The system is not working as intended and can therefore be considered to be in a degraded or fault state. As shown in the upper diagram, the measured discharge pressure P_{current} rarely reaches the target average pressure P_{target} of 11 bar, indicated by the dashed line. As the difference to the target average pressure P_{target} often exceeds 1 bar, this difference is added to the cumulative sum S, which eventually drops below the control limit of −100, indicating a prolonged period of low pressures relative to the target.

The cumulative sum S reaching the control limit may trigger an alert, prompting a need for service, causing the vehicle to enter a safe mode. The safe mode may include operating one or more systems or components of the vehicle at a reduced performance, causing the vehicle to drive at a reduced speed, planning an imminent visit to a service point, or pull over. The safe mode may in some examples be referred to as a “limp home” mode.

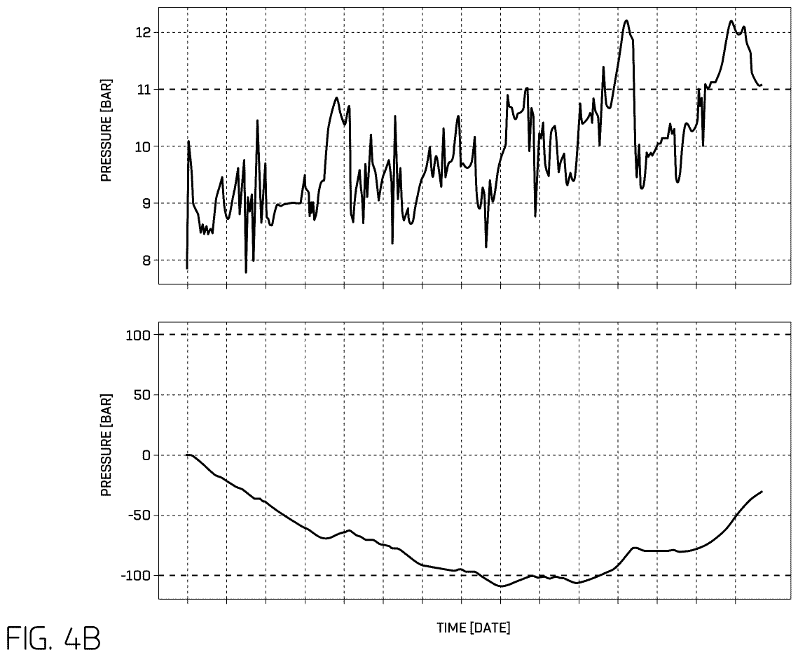

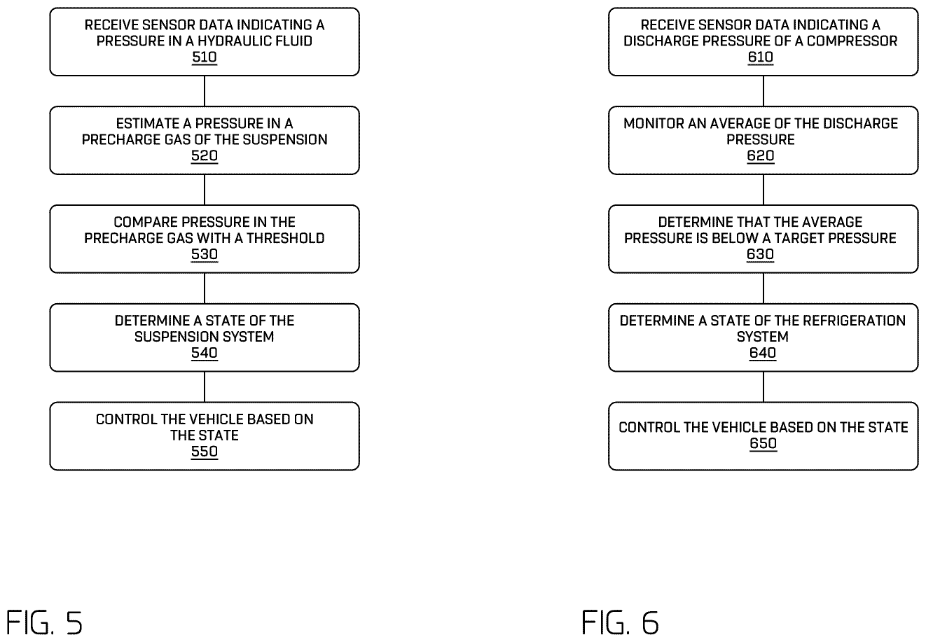

FIGS. 5 and 6 depict flow charts of processes of determining a state of a fluid-operated system of a vehicle and performing an action, associated with the vehicle, based at least in part on the state of the fluid-operated system.

FIG. 5 shows an example wherein the fluid-operated system is a suspension system, which may be configured similarly to the suspension system discussed above in connection with FIGS. 1A and 1B. The process comprises receiving 510 sensor data from a pressure sensor, indicating a pressure of the working fluid of the suspension system. The sensor data may be received 510 from a sensor arranged to measure a pressure in a fluid line of the suspension system, such as a fluid line supplying a spring of the suspension system with hydraulic fluid, or a sensor arranged to measure a pressure in hydraulic fluid in an accumulator of the suspension system. The sensor data may be averaged over a plurality of measurements from a certain time window, such as one or several hours, or one day.

The process further comprises estimating 520 a pressure of the gas in the accumulator (or, in some examples, in a gas chamber of the spring) based at least in part on the pressure of the working fluid and at least in part on a model representing a correlation between the pressure of the working fluid. Various mathematical, statistical, or physical models can be used to estimate 520 the pressure of the gas. In some examples, a constant may be subtracted from the pressure of the working fluid, whereas in other examples a cumulative sum may be monitored to detect extended periods of low pressure. While the latter model might not give a quantitative estimate of the gas pressure, it may still indicate whether the gas pressure is adequate or too low.

The estimated gas pressure may hence be compared 530 to a threshold or control limit, indicating a potential malfunction or degradation of the suspension system 10. In case the estimated gas pressure falls below the threshold, a malfunction or degraded state may be determined 540.

The process further comprises controlling 550 the vehicle based on the determined state. This may be understood as an action being performed, which is associated with the vehicle. The performed action may, for example, include generating a signal indicating that there is malfunction of the suspension, or that there is a need for service of the suspension system because additional gas is needed to be introduced into the system, for example. In further examples, the process may include determining a future point in time when the suspension system may be in a degraded or malfunctioning state. The determining of the future point in time may, for example, include determining a current pressure of the gas present in the gas chamber of the accumulator and/or the spring and extrapolating, or otherwise predict using statistical models, a future gas pressure. The action, associated with the vehicle, may then comprise generating a signal indicating the future point in time in which the predicated gas pressure is below the threshold pressure and there is a need for service of the suspension system. In further examples, the controlling of the vehicle may include operating the vehicle in a safe mode, in which the vehicle may operate at a reduced performance level so as to compensate for the malfunction. This may, for example, include rerouting the vehicle to paths having a smoother surface or allowing a reduced speed to be used. Further examples include driving the vehicle to a test area or service area. A detected or predicted malfunction may hence cause the vehicle to be taken out of service.

FIG. 6 illustrates a flowchart similar to the one in FIG. 5, with the difference that the method is utilized to determine a state of a refrigeration system instead of a suspension system. The refrigeration system may be configured similarly to the refrigeration system discussed above in connection with FIG. 3. The process comprises receiving 610 sensor data from a pressure sensor, indicating a discharge pressure of the compressor of the refrigeration system. The sensor data may be received 610 from a pressure sensor arranged at an outlet of the compressor. The sensor may, in some examples, be integrated into the compressor while it in other examples may be provided as a separate component. The sensor data may be averaged over a plurality of measurement from a time window of, for example, 5 minutes.

The process further comprises monitoring 620 the average of the discharge pressure to detect potential issues. The discharge pressure may, for example, be compared with a target pressure indicating an expected average pressure for a normally functioning system, operating at an adequate refrigerant level. In an example, the process comprises determining that 630 that the average is below the target pressure. This may indicate an insufficiency of refrigerant in the refrigeration circuit. Based on this insufficiency, malfunction state may be determined 640.

In further examples, the discharge pressure may be utilized to predict a future malfunction of the refrigeration system, or a point in time when the refrigeration system may be in a degraded or malfunctioning state due to a leakage of refrigerant. The determining of the future point in time may, for example, include extrapolating, or otherwise predict using statistical models, a future discharge pressure.

The process may further comprise controlling 650 the vehicle based on the determined state, similar to what is described above in connection with FIG. 5. Hence, an action associated with the vehicle may be performed, including generating a signal indicating that there is a (current or predicted) malfunction of the refrigeration system, operating the vehicle in a safe mode, including a reduced performance level to reduce heat generation, rerouting the vehicle to paths allowing reduced speed, driving the vehicle to a test or service area, or taking the vehicle out of service.

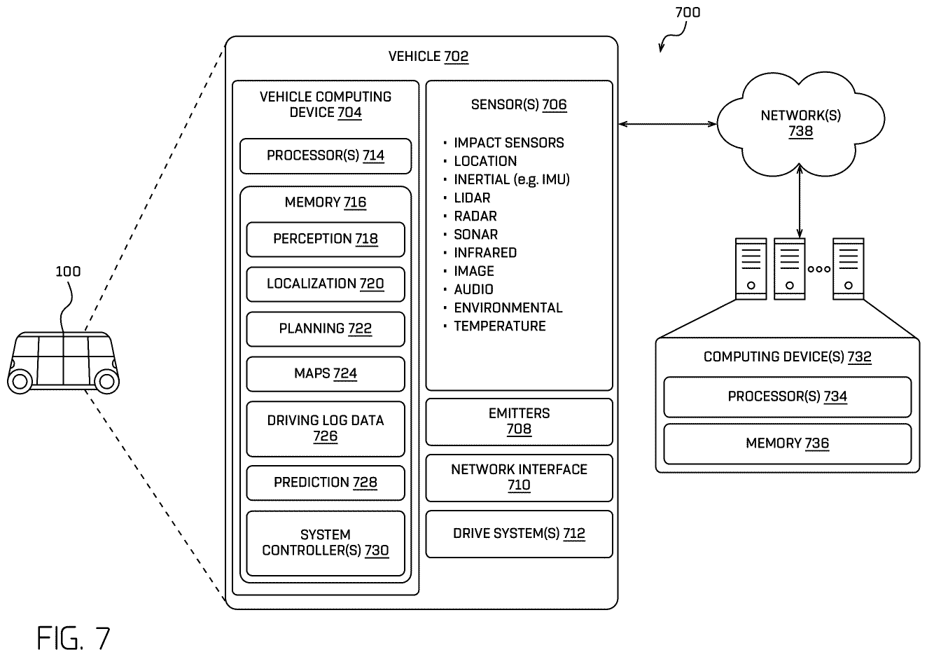

A further example of a vehicle system 700 is depicted in FIG. 7. The vehicle system 700 includes a vehicle 100, which may be the vehicle 100 in FIG. 1A, 1B, or 3. In some instances, the vehicle 100 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the autonomous vehicle 100 may be a fully or partially autonomous vehicle having any other level or classification. Moreover, in some instances, the techniques described herein may be usable in conjunction with non-autonomous vehicles as well.

The vehicle 100 may include one or more vehicle computing device(s) 704, sensor(s) 706 (such as the pressure sensor(s) 182 in FIGS. 1A and 1B), emitter(s) 708, network interface(s) 734, and/or drive system(s) 712. The system 700 may additionally or alternatively comprise computing device(s) 732.

In some instances, the sensor(s) 706 may include LIDAR sensors, radar sensors, ultrasonic transducers, sonar sensors, location sensors (e.g., global positioning system (GPS), compass, etc.), inertial sensors (e.g., inertial measurement units (IMUs), accelerometers, magnetometers, gyroscopes, etc.), image sensors (e.g., red-green-blue (RGB), infrared (IR), intensity, depth, time of flight cameras, etc.), microphones, wheel encoders, environment sensors (e.g., thermometer, hygrometer, light sensors, pressure sensors, etc.), etc. The sensor(s) 706 may include multiple instances of each of these or other types of sensors. For instance, the radar sensors may include individual radar sensors located at the corners, front, back, sides, and/or top of the vehicle 100. As another example, the cameras may include multiple cameras disposed at various locations about the exterior and/or interior of the vehicle 100. The sensor(s) 706 may provide input to the vehicle computing device(s) 704 and/or to computing device(s) 732.

The vehicle 100 may also include emitter(s) 708 for emitting light and/or sound, as described above. The emitter(s) 708 may include interior audio and visual emitter(s) to communicate with passengers of the vehicle 100. Interior emitter(s) may include speakers, lights, signs, display screens, touch screens, haptic emitter(s) (e.g., vibration and/or force feedback), mechanical actuators (e.g., seatbelt tensioners, seat positioners, headrest positioners, etc.), and the like. The emitter(s) 708 may also include exterior emitter(s). Exterior emitter(s) may include lights to signal a direction of travel or other indicator of vehicle action (e.g., indicator lights, signs, light arrays, etc.), and one or more audio emitter(s) (e.g., speakers, speaker arrays, horns, etc.) to audibly communicate with pedestrians or other nearby vehicles, one or more of which comprising acoustic beam steering technology.

The vehicle 100 may also include network interface(s) 710 that enable communication between the vehicle 100 and one or more other local or remote computing device(s). The network interface(s) 710 may facilitate communication with other local computing device(s) on the vehicle 100 and/or the drive component(s) 712. The network interface (s) 710 may additionally or alternatively allow the vehicle to communicate with other nearby computing device(s) (e.g., other nearby vehicles, traffic signals, etc.). The network interface(s) 710 may additionally or alternatively enable the vehicle 100 to communicate with computing device(s) 732 over a network 738. In some examples, computing device(s) 732 may comprise one or more nodes of a distributed computing system (e.g., a cloud computing architecture).

The vehicle 100 may include one or more drive components 712. In some instances, the vehicle 100 may have a single drive component 712. In some instances, the drive component(s) 712 may include one or more sensors to detect conditions of the drive component(s) 712 and/or the surroundings of the vehicle 100. By way of example and not limitation, the sensor(s) of the drive component(s) 712 may include one or more wheel encoders (e.g., rotary encoders) to sense rotation of the wheels of the drive components, inertial sensors (e.g., inertial measurement units, accelerometers, gyroscopes, magnetometers, etc.) to measure orientation and acceleration of the drive component, cameras or other image sensors, ultrasonic sensors to acoustically detect objects in the surroundings of the drive component, lidar sensors, radar sensors, etc. Some sensors, such as the wheel encoders may be unique to the drive component(s) 712. In some cases, the sensor(s) on the drive component(s) 712 may overlap or supplement corresponding systems of the vehicle 100 (e.g., sensor(s) 706).

The drive component(s) 712 may include many of the vehicle systems, including a high voltage battery, a motor to propel the vehicle, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, such as the spring 110 and the accumulator 150 in FIGS. 1A and 1B, a refrigeration system such as the one shown in FIG. 3, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive component(s) 712 may include a drive component controller which may receive and pre-process data from the sensor(s) and to control operation of the various vehicle systems, such as the suspension system 10 or refrigeration system 30. In some instances, the drive component controller may include one or more processors and memory communicatively coupled with the one or more processors. The memory may store one or more components to perform various functionalities of the drive component(s) 712. Furthermore, the drive component(s) 712 may also include one or more communication connection(s) that enable communication by the respective drive component with one or more other local or remote computing device(s).

The vehicle computing device(s) 704 may include processor(s) 714 and memory 716 communicatively coupled with the one or more processors 714. Computing device(s) 732 may also include processor(s) 734, and/or memory 736. The processor(s) 714 and/or 734 may be any suitable processor capable of executing instructions to process data and perform operations as described herein. By way of example and not limitation, the processor(s) 714 and/or 734 may comprise one or more central processing units (CPUs), graphics processing units (GPUs), integrated circuits (e.g., application-specific integrated circuits (ASICs)), gate arrays (e.g., field-programmable gate arrays (FPGAs)), and/or any other device or portion of a device that processes electronic data to transform that electronic data into other electronic data that may be stored in registers and/or memory.

Memory 716 and/or 736 may be examples of non-transitory computer-readable media. The memory 716 and/or 736 may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), non-volatile/Flash-type memory, or any other type of memory capable of storing information. The architectures, systems, and individual elements described herein may include many other logical, programmatic, and physical components, of which those shown in the accompanying figures are merely examples that are related to the discussion herein.

In some instances, the memory 716 and/or memory 736 may store a perception component 718, localization component 720, planning component 722, map(s) 724, driving log data 726, prediction component 728, and/or system controller(s) 730—zero or more portions of any of which may be hardware, such as GPU(s), CPU(s), and/or other processing units.

The perception component 718 may detect object(s) in in an environment surrounding the vehicle 100 (e.g., identify that an object exists), classify the object(s) (e.g., determine an object type associated with a detected object), segment sensor data and/or other representations of the environment (e.g., identify a portion of the sensor data and/or representation of the environment as being associated with a detected object and/or an object type), determine characteristics associated with an object (e.g., a track identifying current, predicted, and/or previous position, heading, velocity, and/or acceleration associated with an object), and/or the like. Data determined by the perception component 718 is referred to as perception data. The perception component 718 may be configured to associate a bounding region (or other indication) with an identified object. The perception component 718 may be configured to associate a confidence score associated with a classification of the identified object with an identified object. In some examples, objects, when rendered via a display, can be colored based on their perceived class. The object classifications determined by the perception component 718 may distinguish between different object types such as, for example, a passenger vehicle, a pedestrian, a bicyclist, motorist, a delivery truck, a semi-truck, traffic signage, and/or the like.

In at least one example, the localization component 720 may include hardware and/or software to receive data from the sensor(s) 706 to determine a position, velocity, and/or orientation of the vehicle 100 (e.g., one or more of an x-, y-, z-position, roll, pitch, or yaw). For example, the localization component 720 may include and/or request/receive map(s) 724 of an environment and can continuously determine a location, velocity, and/or orientation of the autonomous vehicle 100 within the map(s) 724. In some instances, the localization component 720 may utilize SLAM (simultaneous localization and mapping), CLAMS (calibration, localization and mapping, simultaneously), relative SLAM, bundle adjustment, non-linear least squares optimization, and/or the like to receive image data, lidar data, radar data, IMU data, GPS data, wheel encoder data, and the like to accurately determine a location, pose, and/or velocity of the autonomous vehicle. In some instances, the localization component 720 may provide data to various components of the vehicle 702 to determine an initial position of an autonomous vehicle for generating a trajectory and/or for generating map data, as discussed herein. In some examples, localization component 720 may provide, to the perception component 718, a location and/or orientation of the vehicle 702 relative to the environment and/or sensor data associated therewith.

The planning component 722 may receive a location and/or orientation of the vehicle 100 from the localization component 720 and/or perception data from the perception component 718 and may determine instructions for controlling operation of the vehicle 702 based at least in part on any of this data. In some examples, determining the instructions may comprise determining the instructions based at least in part on a format associated with a system with which the instructions are associated (e.g., first instructions for controlling motion of the autonomous vehicle may be formatted in a first format of messages and/or signals (e.g., analog, digital, pneumatic, kinematic) that the system controller(s) 730 and/or drive component(s) 712 may parse/cause to be carried out, second instructions for the emitter(s) 708 may be formatted according to a second format associated therewith).

The driving log data 726 may comprise sensor data, perception data, and/or scenario labels collected/determined by the vehicle 100 (e.g., by the perception component 718), as well as any other message generated and or sent by the vehicle 100 during operation including, but not limited to, control messages, error messages, etc. In some examples, the vehicle 100 may transmit the driving log data 726 to the computing device(s) 732.

The prediction component 728 may generate one or more probability maps representing prediction probabilities of possible locations of one or more objects in an environment. For example, the prediction component 728 may generate one or more probability maps for vehicles, pedestrians, animals, and the like within a threshold distance from the vehicle 100. In some examples, the prediction component 728 may measure a track of an object and generate a discretized prediction probability map, a heat map, a probability distribution, a discretized probability distribution, and/or a trajectory for the object based on observed and predicted behavior. In some examples, the one or more probability maps may represent an intent of the one or more objects in the environment. In some examples, the planner component 722 may be communicatively coupled to the prediction component 728 to generate predicted trajectories of objects in an environment. For example, the prediction component 728 may generate one or more predicted trajectories for objects within a threshold distance from the vehicle 100. In some examples, the prediction component 728 may measure a trace of an object and generate a trajectory for the object based on observed and predicted behavior. Although prediction component 728 is shown on a vehicle 100 in this example, the prediction component 728 may also be provided elsewhere, such as in a remote computing device. In some examples, a prediction component may be provided at both a vehicle and a remote computing device. These components may be configured to operate according to the same or a similar algorithm.

The memory 716 and/or 736 may additionally or alternatively store a mapping system, a planning system, a ride management system, etc. Although perception component 718 and/or planning component 722 are illustrated as being stored in memory 716, perception component 718 and/or planning component 722 may include processor-executable instructions, machine-learned model(s) (e.g., a neural network), and/or hardware.

As described herein, the localization component 720, the perception component 718, the planning component 722, and/or other components of the system 700 may comprise one or more ML models. For example, the localization component 720, the perception component 718, and/or the planning component 722 may each comprise different ML model pipelines. In some examples, an ML model may comprise a neural network. An exemplary neural network is a biologically inspired algorithm which passes input data through a series of connected layers to produce an output. Each layer in a neural network can also comprise another neural network or can comprise any number of layers (whether convolutional or not). As can be understood in the context of this disclosure, a neural network can utilize machine-learning, which can refer to a broad class of such algorithms in which an output is generated based on learned parameters.

Although discussed in the context of neural networks, any type of machine-learning can be used consistent with this disclosure. For example, machine-learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAD)), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet-50, ResNet-101, VGG, DenseNet, PointNet, and the like. In some examples, the ML model discussed herein may comprise PointPillars, SECOND, top-down feature layers (e.g., see U.S. patent application Ser. No. 15/963,833, which is incorporated in its entirety herein), and/or VoxelNet. Architecture latency optimizations may include MobilenetV2, Shufflenet, Channelnet, Peleenet, and/or the like. The ML model may comprise a residual block such as Pixor, in some examples.

Memory 720 may additionally or alternatively store one or more system controller(s) 730, which may be configured to control steering, propulsion, braking, safety, emitters, communication, and other systems of the vehicle 100. These system controller(s) 730 may communicate with and/or control corresponding systems of the drive component(s) 712 and/or other components of the vehicle 100.

It should be noted that while FIG. 7 is illustrated as a distributed system, in alternative examples, components of the vehicle 100 may be associated with the computing device(s) 732 and/or components of the computing device(s) 732 may be associated with the vehicle 100. That is, the vehicle 702 may perform one or more of the functions associated with the computing device(s) 732, and vice versa.

### Example Clauses

A: A system comprising: a suspension system of a vehicle, comprising a working fluid and an accumulator, the accumulator comprising a gas arranged to pressurize the working fluid; one or more processors; and one or more non-transitory computer-readable media storing instructions executable by the one or more processors, wherein the instructions, when executed, cause the system to perform operations comprising: receiving sensor data indicating a pressure of the working fluid; estimating a pressure of the gas in the accumulator based at least in part on the pressure of the working fluid and at least in part on a model representing a correlation between the pressure of the working fluid and the pressure of the gas; comparing the pressure of the gas with a predetermined value; determining, based at least in part on the comparison, a state of the suspension system; and controlling the vehicle based at least in part on the state of the suspension system.

B: The vehicle of clause A, wherein the estimated pressure of the gas is a predicted future pressure of the gas.

C: The vehicle of clause A or B, wherein the instructions further cause the system to perform actions comprising estimating, based at least in part on the pressure of the working fluid and at least in part the model the pressure of the gas in the accumulator, a time until the suspension system reaches a fault state.

D: The vehicle of any of clauses A-C, wherein the instructions further cause the system to perform actions comprising detecting, based at least in part on the pressure of the working fluid and at least in part on the model, an event; and controlling the operation of the vehicle based at least in part on the event.

E: The vehicle of clause D, wherein the instructions further cause the system to perform actions comprising requesting, based at least in part on the event, a service of the suspension system.

F: A method comprising: receiving sensor data indicating a first characteristic of a fluid-operated system of a vehicle; estimating a second characteristic of the system, based at least in part on the sensor data and at least in part on a model representing a correlation between the first characteristic and the second characteristic; determining, based at least in part on the second characteristic, a state of the system; and controlling the vehicle based at least in part on the state of the system.

G: The method according to clause F, comprising requesting, based at least in on the state of the system, a service of the system.

H: The method of clause F or G, wherein: the system is a suspension system; the first characteristic is a pressure of a working fluid of the suspension system; and the second characteristic is a pressure of a gas arranged to pressurize the working fluid.

I: The method of clause H, comprising predicting, based at least in part on the model, a future pressure of the gas.

J: The method of clause H or I, comprising comparing the pressure of the gas with a predetermined value; and determining a fault state of the system based at least in part on the pressure of the gas being below the predetermined value.

K: The method of clause F or G, wherein the system comprises a refrigeration system; and the first characteristic is a discharge pressure of a compressor of the refrigeration system.

L: The method of clause K, wherein the model is a deviation detection model, and wherein the method further comprises monitoring, based at least in part on the model, an average of the discharge pressure over a period of time; determining, based at least in part on the model, that the average is below a predetermined target pressure; and determining the state of the system based at least in part on the average being below the predetermined target pressure.

M: One or more non-transitory computer-readable media storing instructions executable by one or more processors, wherein the instructions, when executed, cause the one or more processors to perform operations comprising: receiving sensor data indicating a first characteristic of a fluid-operated system of a vehicle; estimating a second characteristic of the system, based at least in part on the sensor data and at least in part on a model representing a correlation between the first characteristic and the second characteristic; determining, based at least in part on the second characteristic, a state of the system; and controlling the vehicle based at least in part on the state of the system.

N: The one or more non-transitory computer-readable media of clause M, wherein the operations further comprise causing the vehicle to operate in a safe mode.

O: The one or more non-transitory computer-readable media of clause M or N, wherein the operations further comprise driving the vehicle to a service point.

P: The one or more non-transitory computer-readable media of any of clauses M-O, wherein: the system comprises a suspension system; the first characteristic is a pressure of a working fluid of the suspension system; and the second characteristic is a pressure of a gas arranged to pressurize the working fluid.

Q: The one or more non-transitory computer-readable media of clause P, wherein the operations further comprise predicting, based at least in part on the model, a future pressure of the gas.

R: The one or more non-transitory computer-readable media of clause P or Q, wherein the model comprises a rolling forecast model configured to predict the future pressure of the gas.

S: The one or more non-transitory computer-readable media of any of clauses M-O, wherein: the system comprises a refrigeration system; and the first characteristic is a discharge pressure of a compressor of the refrigeration system.

T: The one or more non-transitory computer-readable media of clause S, wherein the operations further comprise monitoring a deviation between the discharge pressure and a predetermined target pressure; and determining the state of the system based at least in part on the average being below the predetermined target pressure.

### CONCLUSION

While one or more examples of the techniques described herein have been described, various alterations, additions, permutations, and equivalents thereof are included within the scope of the techniques described herein.

In the description of examples, reference is made to the accompanying drawings that form a part hereof, which show by way of illustration specific examples of the claimed subject matter. It is to be understood that other examples may be used and that changes or alterations, such as structural changes, may be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub computations with the same results.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code components and/or computer-executable instructions executed by one or more computers or processors, hardware, or some combination thereof. Some or all of the methods may alternatively be embodied in specialized computer hardware.

At least some of the processes discussed herein are illustrated as logical flow charts, each operation of which represents a sequence of operations that can be implemented in hardware, software, or a combination thereof. In the context of software, the operations represent computer-executable instructions stored on one or more non-transitory computer-readable storage media that, when executed by one or more processors, cause a computer or autonomous vehicle to perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted or executed out of order from that shown or discussed, including substantially synchronously, in reverse order, with additional operations, or omitting operations, depending on the functionality involved as would be understood by those skilled in the art. Note that the term substantially may indicate a range. For example, substantially simultaneously may indicate that two activities occur within a time range of each other, substantially a same dimension may indicate that two elements have dimensions within a range of each other, and/or the like.

Many variations and modifications may be made to the above-described examples, the elements of which are to be understood as being among other acceptable examples. All such modifications and variations are intended to be included herein within the scope of this disclosure and protected by the following claims.

What is claimed is:

1. A system comprising:
a suspension system of a vehicle, comprising a working fluid and an accumulator, the accumulator comprising a gas arranged to pressurize the working fluid;
one or more processors; and
one or more non-transitory computer-readable media storing instructions executable by the one or more processors, wherein the instructions, when executed, cause the system to perform operations comprising:
receiving sensor data indicating a pressure of the working fluid;
estimating a pressure of the gas in the accumulator based at least in part on the pressure of the working fluid and at least in part on a model representing a correlation between the pressure of the working fluid and the pressure of the gas;
comparing the pressure of the gas with a predetermined value;
determining, based at least in part on the comparison, a state of the suspension system; and
controlling the vehicle based at least in part on the state of the suspension system.

2. The vehicle of claim 1, wherein the estimated pressure of the gas is a predicted future pressure of the gas.

3. The vehicle of claim 2, wherein the instructions further cause the system to perform actions comprising:
estimating, based at least in part on the pressure of the working fluid and at least in part the model the pressure of the gas in the accumulator, a time until the suspension system reaches a fault state.

4. The vehicle of claim 1, wherein the instructions further cause the system to perform actions comprising:
detecting, based at least in part on the pressure of the working fluid and at least in part on the model, an event; and
controlling the operation of the vehicle based at least in part on the event.

5. The vehicle of claim 4, wherein the instructions further cause the system to perform actions comprising:
requesting, based at least in part on the event, a service of the suspension system.

6. A method comprising:
receiving sensor data indicating a first characteristic of a fluid-operated system of a vehicle;
estimating a second characteristic of the system, based at least in part on the sensor data and at least in part on a model representing a correlation between the first characteristic and the second characteristic;
determining, based at least in part on the second characteristic, a state of the system; and
controlling the vehicle based at least in part on the state of the system.

7. The method according to claim 6, comprising:
requesting, based at least in on the state of the system, a service of the system.

8. The method of claim 6, wherein:
the system is a suspension system;
the first characteristic is a pressure of a working fluid of the suspension system; and
the second characteristic is a pressure of a gas arranged to pressurize the working fluid.

9. The method of claim 8, comprising:
predicting, based at least in part on the model, a future pressure of the gas.

10. The method of claim 8, comprising:
comparing the pressure of the gas with a predetermined value; and
determining a fault state of the system based at least in part on the pressure of the gas being below the predetermined value.

11. The method of claim 6, wherein:
the system comprises a refrigeration system; and
the first characteristic is a discharge pressure of a compressor of the refrigeration system.

12. The method of claim 11, wherein the model is a deviation detection model, and wherein the method further comprises:
monitoring, based at least in part on the model, an average of the discharge pressure over a period of time;
determining, based at least in part on the model, that the average is below a predetermined target pressure; and
determining the state of the system based at least in part on the average being below the predetermined target pressure.

13. One or more non-transitory computer-readable media storing instructions executable by one or more processors, wherein the instructions, when executed, cause the one or more processors to perform operations comprising:
receiving sensor data indicating a first characteristic of a fluid-operated system of a vehicle;
estimating a second characteristic of the system, based at least in part on the sensor data and at least in part on a model representing a correlation between the first characteristic and the second characteristic;
determining, based at least in part on the second characteristic, a state of the system; and
controlling the vehicle based at least in part on the state of the system.

14. The one or more non-transitory computer-readable media of claim 13, wherein the operations further comprise causing the vehicle to operate in a safe mode.

15. The one or more non-transitory computer-readable media of claim 14, wherein the operations further comprise driving the vehicle to a service point.

16. The one or more non-transitory computer-readable media of claim 15, wherein:
the system comprises a suspension system;
the first characteristic is a pressure of a working fluid of the suspension system; and
the second characteristic is a pressure of a gas arranged to pressurize the working fluid.

17. The one or more non-transitory computer-readable media of claim 16, wherein the operations further comprise predicting, based at least in part on the model, a future pressure of the gas.

18. The one or more non-transitory computer-readable media of claim 17, wherein the model comprises a rolling forecast model configured to predict the future pressure of the gas.

19. The one or more non-transitory computer-readable media of claim 13, wherein:
the system comprises a refrigeration system; and
the first characteristic is a discharge pressure of a compressor of the refrigeration system.

20. The one or more non-transitory computer-readable media of claim 19, wherein the operations further comprise:
monitoring a deviation between the discharge pressure and a predetermined target pressure; and
determining the state of the system based at least in part on the average being below the predetermined target pressure.
